(19) United States
(12) Patent Application Publication
(10) Pub. No.: US 2026/0200776 A1
(43) Pub. Date: Jul. 16, 2026

(54) CONCRETE WASTEWATER TREATMENT DEVICE AND SYSTEM

(71) Applicant: YONGHONG WANG, Yongzhou City (CN)

(72) Inventor: YONGHONG WANG, Yongzhou City (CN)

(21) Appl. No.: 19/274,661

(22) Filed: Jul. 21, 2025

(30) Foreign Application Priority Data
Jan. 16, 2025 (AE) P2025-00164

(51) Int. Cl. C02F 3/12; C02F 1/66; C02F 103/34

(52) U.S. Cl. CPC C02F 3/1278; C02F 1/66; C02F 2103/34; C02F 2305/14

(57) ABSTRACT

Provided are concrete wastewater treatment device and system, pertaining to the field of concrete wastewater treatment. The concrete wastewater treatment device includes a first wall and a CO₂ input pipe. The first wall encloses a first chamber, with the first wall being provided with a first liquid inlet and a first liquid outlet. The first liquid outlet is positioned higher than the first liquid inlet. The first chamber is equipped with a groove for accommodating reducing agent powder, which includes at least one of elemental iron, divalent iron compounds, and elemental aluminum. The CO₂ input pipe is used to deliver CO₂ into the first chamber, with the gas outlet end of the CO₂ input pipe being close to or located within the groove. The gas outlet direction of the CO₂ input pipe is configured such that the conveyed CO₂ can induce turbulence and agitation in the reducing agent powder.

### CROSS REFERENCE TO RELATED APPLICATIONS

This application claims the benefit of priority of UAE Patent Application No. P2025-00164, filed 16 Jan. 2025. The contents of the above application is incorporated by reference as if fully set forth herein in its entirety.

### TECHNICAL FIELD

This application relates to the field of concrete wastewater treatment, and in particular, to a concrete wastewater treatment device and system.

### BACKGROUND ART

Concrete refers to a general term for engineering composite materials in which aggregates are bonded into a whole by a cementitious material. The term “concrete” typically refers to cement concrete, which uses cement as the cementitious material, sand and gravel as aggregates, and is mixed with water (which may contain admixtures and mineral admixtures) in a certain proportion and stirred. It is widely used in civil engineering.

Concrete wastewater refers to wastewater generated during concrete production, mainly from cleaning concrete mixer trucks, concrete pump trucks, and concrete mixing hosts. The concrete wastewater in this invention also includes wastewater generated during the production of other cement products, such as cement bricks and precast concrete panels. According to the discharge standards of environmental protection departments in various countries, such concrete wastewater cannot be directly discharged due to its high pH (alkaline), high TDS (total dissolved solids), and excessive heavy metals (mainly hexavalent chromium), and must undergo harmless treatment before being discharged or recycled.

In existing harmless treatment of concrete wastewater, strong acids are used to adjust the pH value, and flocculants are used as sedimentation media. This process introduces secondary pollution (chloride ions or sulfate ions) and has complex equipment and very high operating costs.

In addition, traditional treatment methods for hexavalent chromium, a heavy metal in concrete wastewater, typically use the reducibility of sulfite. This method requires the reaction to be controlled in an acidic environment, leading to two problems: 1. After SO₃²⁻ is oxidized to SO₄²⁻, SO₄²⁻ becomes a pollutant in water. In some cases, barium ions must be added to precipitate and remove sulfate, increasing treatment steps and chemical costs. 2. In traditional treatment methods, since SO₃²⁻ must become HSO₃⁻ in an acidic environment, and the form of hexavalent chromium changes from CrO₄²⁻ in an alkaline environment to Cr₂O₇²⁻ in an acidic environment, the pH must be adjusted from 12.0-13.3 to 3.5-4.0. Under such acidic conditions, hexavalent chromium (Cr(VI)) is rapidly reduced to trivalent chromium (Cr(III)). After this process is completed, alkaline chemicals must be added again to adjust the pH to neutral. This also increases treatment steps, chemical costs, and the complexity of control, adjustment, operation, and maintenance.

In summary, the traditional treatment scheme has several obvious weaknesses: 1. The use of strong acids is highly unfriendly in terms of cost and the environment. 2. Chemicals added during treatment cause new pollution sources. 3. It cannot reduce TDS (total dissolved solids), and reverse osmosis is often required as post-treatment, increasing equipment and maintenance costs, while also posing concentrated water discharge problems. 4. The treatment process is complex, with multiple conflicting links, complex control of treatment procedures, high chemical costs, and difficult operation and maintenance.

### SUMMARY

The objective of the embodiments of this application is to provide a concrete wastewater treatment device and system that can address at least one of the above technical problems.

First aspect, an embodiment of this application provides a concrete wastewater treatment device, including a first wall and a CO₂ input pipe.

The first wall encloses a first chamber for accommodating and treating concrete wastewater. The first wall is provided with a first liquid inlet and a first liquid outlet communicating with the first chamber, where the first liquid outlet is positioned higher than the first liquid inlet. The first chamber has a groove for accommodating reducing agent powder, which includes at least one of elemental iron, divalent iron compounds, and elemental aluminum. The CO₂ input pipe is used to deliver CO₂ into the first chamber, with its gas outlet end located near or inside the groove. The gas outlet direction is configured such that the delivered CO₂ can induce turbulence and agitation in the reducing agent powder.

The concrete wastewater treatment device provided in this application has a simple structure and low maintenance cost. It not only uses the combination of reducing agent powder and CO₂ to effectively neutralize the alkalinity of concrete wastewater, remove Ca²⁺ and CrO₄²⁻, and reduce total dissolved solids, but also through structural improvements, places the reducing agent powder at the CO₂ outlet. The CO₂ at the outlet reacts with water to provide a weakly acidic environment for the reducing agent, accelerating the reaction rate. Meanwhile, the injected CO₂ airflow provides a function similar to mechanical stirring for the reducing agent powder, inducing turbulence and agitation, which also accelerates the reaction rate and improves the treatment efficiency of concrete wastewater. Moreover, since both the weakly acidic environment and the mechanical stirring-like function for the reducing agent are caused by CO₂ injection, no additional devices or chemicals are added, resulting in low concrete wastewater treatment costs and good environmental friendliness.

In one possible implementation, the groove is located at the bottom of the first chamber in the gravitational direction. The gas outlet end of the CO₂ input pipe extends downward in the gravitational direction and penetrates into the groove, with the gas outlet direction of the CO₂ input pipe facing the bottom wall of the groove.

In this implementation, since the gas outlet direction of the CO₂ input pipe faces the bottom wall of the groove, the output CO₂ rushes toward the bottom wall of the groove and rebounds, which helps fully agitate the reducing agent powder and improve the treatment efficiency and effect of concrete wastewater.

In one possible implementation, the concrete wastewater treatment device further includes a first sedimentation tank and an output pipe. The first sedimentation tank is provided with a first overflow port and a sewage discharge port. The output pipe includes a liquid inlet end and a liquid outlet end, where the liquid inlet end is connected to the first liquid outlet of the first chamber, the liquid outlet end is connected to the first sedimentation tank, and the liquid outlet end is positioned lower than the first overflow port in the gravitational direction.

In this implementation, since the output pipe discharges the reacted concrete wastewater from the first chamber to the first sedimentation tank for sedimentation, calcium carbonate, iron hydroxide, chromium hydroxide, etc., formed in the reacted concrete wastewater can precipitate in the first sedimentation tank and be discharged through the sewage discharge port, while the upper clear liquid can be discharged through the first overflow port. At the same time, since the liquid outlet end is positioned lower than the first overflow port in the gravitational direction, it can prevent the concrete wastewater entering the first sedimentation tank from the first chamber from directly flowing out of the first overflow port, allowing the concrete wastewater input into the first sedimentation tank to fully settle and reducing the TDS of the concrete wastewater flowing out of the first overflow port.

In one possible implementation, the output pipe includes a flexible section and a rigid section. One end of the flexible section serves as the liquid inlet end, and the other end is connected to the rigid section, with the end of the rigid section opposite to the flexible section serving as the liquid outlet end. The length of the flexible section is greater than the distance between the first liquid outlet and the rigid section, and the flexible section is configured such that the buoyancy force from the concrete wastewater is greater than or equal to its gravity, allowing the flexible section to float in the concrete wastewater.

In this implementation, through the above configuration, the flexible section can float in the concrete wastewater and deform with changes in the liquid level, reducing or inhibiting scaling in the output pipe, lowering the risk of blockage, and extending the service life of the concrete wastewater treatment device.

In one possible implementation, the first sedimentation tank further includes a baffle connected to the side wall of the first sedimentation tank, with a channel formed between the baffle and the bottom wall of the first sedimentation tank. The baffle divides the first sedimentation tank into a main section and an overflow section that are in communication at the bottom. The first chamber and the flexible section are located in the main section, the rigid section is connected to the top of the baffle, the liquid outlet end is located in the overflow section, and the first overflow port is formed in the overflow section.

In this implementation, through the above configuration, the position of the rigid section can be fixed, which helps to pull the flexible section, ensuring that the flexible section always floats in the concrete wastewater during use. At the same time, using the baffle to divide the first sedimentation tank into a main section and an overflow section that are in communication at the bottom, with the first overflow port formed in the overflow section, is conducive to the concrete wastewater fully settling in the first sedimentation tank before overflowing through the first overflow port, reducing the TDS of the concrete wastewater flowing out of the first overflow port.

In one possible implementation, the rigid section is provided with a pH sensor.

In this implementation, using the pH sensor to monitor the pH of the concrete wastewater output from the rigid section helps control the CO₂ flow and the amount of reducing agent added based on the data obtained from the pH sensor, which is conducive to improving the treatment effect of concrete wastewater.

In one possible implementation, the concrete wastewater treatment device further includes a second wall sleeved outside the first wall, forming a second chamber between the second wall and the first wall. The second chamber has a second liquid outlet, which is positioned higher than the first liquid outlet in the gravitational direction, and the second liquid outlet is connected to the liquid inlet end.

In this implementation, the provision of the second chamber helps CO₂ further react sufficiently with calcium ions, etc. At the same time, the closed and connected first chamber, second chamber, and output pipe extend the output path of CO₂ to the first sedimentation tank, helping CO₂ react fully and reducing CO₂ overflow and waste.

In one possible implementation, the concrete wastewater treatment device further includes a reducing agent addition mechanism, which includes a storage chamber for carrying the reducing agent powder. The storage chamber is located above the first chamber in the gravitational direction, the outlet of the storage chamber is connected to the first chamber, and a valve is provided at the outlet of the storage chamber.

In this implementation, through the above configuration, the reducing agent powder can be added to the first chamber under gravity, with a simple structure and easy operation, which helps reduce costs.

Second aspect, an embodiment of this application provides a concrete wastewater treatment system, including the concrete wastewater treatment device provided in the first aspect of this application, a sand filter, and a clear water tank. The concrete wastewater treated by the concrete wastewater treatment device is delivered to the sand filter for filtration, and the filtered concrete wastewater is delivered to the clear water tank.

In this implementation, through the improvement of the concrete wastewater treatment device, not only does it use the combination of reducing agent powder and CO₂ to effectively neutralize the alkalinity of concrete wastewater, remove Ca²⁺ and CrO₄²⁻, and reduce total dissolved solids, but also through structural improvements and coordination, the reducing agent powder is placed at the CO₂ outlet. The CO₂ at the outlet reacts with water to provide a weakly acidic environment for the reducing agent, accelerating the reaction rate. At the same time, the injected CO₂ airflow provides a function similar to mechanical stirring for the reducing agent powder, inducing turbulence and agitation, which also accelerates the reaction rate and improves the treatment efficiency of concrete wastewater. Moreover, since both the weakly acidic environment and the mechanical stirring-like function for the reducing agent are caused by CO₂ injection, no additional devices or chemicals are added, resulting in low concrete wastewater treatment costs and good environmental friendliness.

In one possible implementation, the concrete wastewater treatment system further includes a second sedimentation tank and a water storage tank. The concrete wastewater treated by the concrete wastewater treatment device is delivered to the second sedimentation tank for sedimentation, the second sedimentation tank is connected to the water storage tank via an overflow pipe, and the sand filter receives the concrete wastewater in the water storage tank via a water pump.

By introducing a second sedimentation tank, it is conducive to full sedimentation to reduce TDS, improve the cleanliness of the concrete wastewater output to the sand filter, and reduce the requirements for the sand filter.

### BRIEF DESCRIPTION OF DRAWINGS

To more clearly illustrate the technical solutions of the embodiments of this application, the following briefly introduces the drawings used in the embodiments. It should be understood that the following drawings only show some embodiments of this application and should not be regarded as limiting the scope. Those of ordinary skill in the art can obtain other related drawings based on these drawings without creative efforts.

FIG. 1 is a schematic structural diagram of a concrete wastewater treatment system provided in some embodiments of this application;

FIG. 2 is a schematic structural diagram of a concrete wastewater treatment device provided in some embodiments of this application.

Reference numerals: 1000—Concrete wastewater treatment system; 10—Concrete wastewater treatment device; 20—Sand filter; 21—First water pump; 30—Clean water tank; 40—Second sedimentation tank; 50—Water storage tank; 60—Wastewater tank; 61—Second water pump; 70—CO2 gas source; 100—First wall; 101—First chamber; 102—First liquid inlet; 103—First liquid outlet; 104—Groove; 160—Reducing agent powder; 110—CO₂ input pipe; 111—Gas outlet end; 120—First sedimentation tank; 121—First overflow port; 122—Sewage discharge port; 123—Baffle; 124—Main section; 125—Overflow section; 130—Output pipe; 131—Flexible segment; 132—Liquid inlet end; 133—Rigid segment; 134—Liquid outlet end; 135—pH sensor; 140—Second wall; 141—Second chamber; 142—Second liquid outlet; 150—Reducing agent addition mechanism; 151—Storage chamber; 152—Valve.

### DETAILED DESCRIPTION OF EMBODIMENTS

To make the objectives, technical solutions, and advantages of the embodiments of this application clearer, the technical solutions in the embodiments of this application will be clearly and completely described below in conjunction with the drawings in the embodiments of this application. Obviously, the described embodiments are some, but not all, of the embodiments of this application. The components of the embodiments of this application generally described and illustrated in the figures herein can be arranged and designed in various different configurations.

Thus, the following detailed description of the embodiments of this application provided in the figures is not intended to limit the scope of the claimed application but merely represents selected embodiments of this application. All other embodiments obtained by those of ordinary skill in the art without creative efforts based on the embodiments of this application shall fall within the protection scope of this application.

It should be noted that similar reference numerals and letters denote similar items in the following figures, so once an item is defined in one figure, it does not require further definition and explanation in subsequent figures.

In the description of this application, it should be noted that the terms “inner,” “outer,” “upper,” “top,” “bottom,” and similar terms indicate orientations or positional relationships based on the orientations or positional relationships shown in the drawings or the usual placement orientations or positional relationships when the application product is used, and are only for convenience in describing this application and simplifying the description, rather than indicating or implying that the referred device or element must have a specific orientation, be constructed in a specific orientation, and operate, and thus should not be construed as limiting this application. Additionally, the terms “first,” “second,” “third,” etc., are used for distinguishing descriptions only and should not be construed as indicating or implying relative importance.

In the description of this application, it should also be noted that unless otherwise clearly specified and limited, the terms “disposed,” “installed,” “connected,” and “connected” should be interpreted broadly. For example, they may be fixed connections, detachable connections, or integral connections; they may be direct connections or indirect connections via intermediate media; or they may be internal communications between two elements. For those of ordinary skill in the art, the specific meanings of the above terms in this application can be understood in specific contexts.

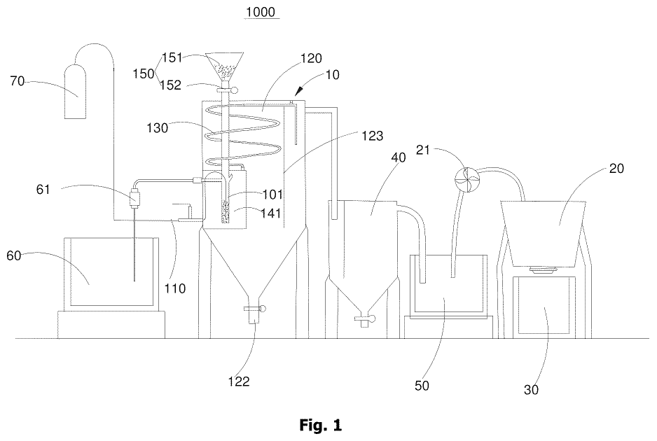

As shown in FIG. 1, the concrete wastewater treatment system 1000 includes a concrete wastewater treatment device 10, a sand filter 20, and a clean water tank 30. The concrete wastewater treated by the concrete wastewater treatment device 10 is delivered to the sand filter 20 for filtration, and the filtered concrete wastewater is delivered to the clean water tank 30.

The concrete wastewater treatment system 1000 further includes a second sedimentation tank 40 and a water storage tank 50. The concrete wastewater treated by the concrete wastewater treatment device 10 is delivered to the second sedimentation tank 40 for sedimentation. The second sedimentation tank 40 is connected to the water storage tank 50 via an overflow pipe, and the sand filter 20 receives the concrete wastewater in the water storage tank 50 via a first water pump 21.

It should be noted that the specific configurations of the sand filter 20, clean water tank 30, second sedimentation tank 40, and water storage tank 50 can refer to related technologies.

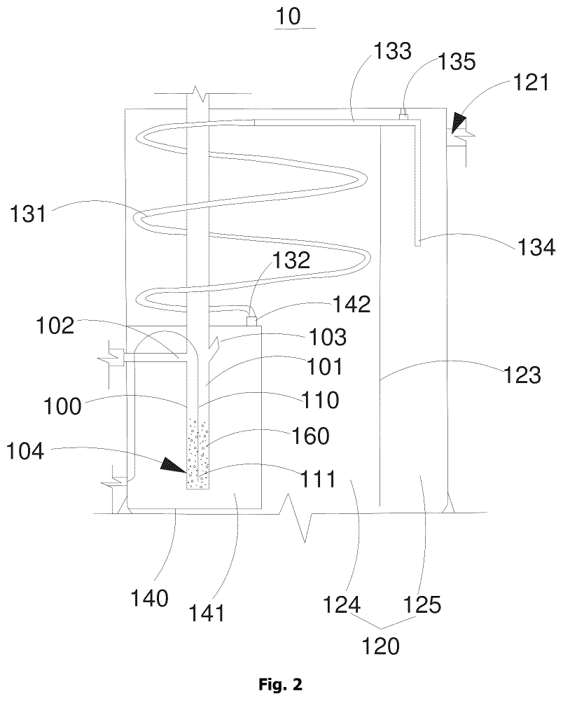

As shown in FIGS. 1 and 2, the concrete wastewater treatment device 10 includes a first wall 100 and a CO₂ input pipe 110.

The first wall 100 encloses a first chamber 101 for accommodating and treating concrete wastewater. The first wall 100 is provided with a first liquid inlet 102 and a first liquid outlet 103 communicating with the first chamber 101, where the first liquid outlet 103 is positioned higher than the first liquid inlet 102. The first chamber 101 has a groove 104 for accommodating reducing agent powder 160, which includes at least one of elemental iron, divalent iron compounds, and elemental aluminum.

The CO₂ input pipe 110 is used to deliver CO₂ into the first chamber 101. The gas outlet end 111 of the CO₂ input pipe 110 is close to or located in the groove 104, and the gas outlet direction of the CO₂ input pipe 110 is configured such that the delivered CO₂ can induce turbulence and agitation in the reducing agent powder 160.

The first liquid inlet 102 can pump untreated concrete wastewater from the wastewater tank 60 via the second water pump 61.

The main components of the concrete wastewater include Ca²⁺, CrO₄²⁻, OH⁻, and water.

The air inlet end of the CO2 input pipe 110 can be connected to a CO₂ gas source 70, such as a CO₂ gas cylinder.

CO₂ provides the following functions: A. It supplies hydrogen ions to neutralize alkaline water (OH⁻) . B. It provides a locally weak acidic environment for the rapid oxidation reaction of the reducing agent powder 160. C. It provides aeration agitation similar to mechanical stirring for the rapid oxidation reaction of the reducing agent powder 160. D. It supplies carbonate ions to precipitate calcium ions, ultimately reducing TDS (total dissolved solids). E. All injected carbon dioxide eventually precipitates as calcium carbonate, meaning that the carbon dioxide is discharged from the water system as carbonate precipitates, simultaneously removing calcium ions without introducing new pollutants.

The reducing agent powder 160 provides the following functions: A. It provides a reducing agent to reduce hexavalent chromium to trivalent chromium. B. It provides a flocculant for rapid sedimentation in the system. C. The reducing agent powder 160 added during treatment, such as iron powder, ultimately forms iron hydroxide precipitates, which are discharged from the water system without introducing new pollutants.

In other words, this application uses a combination of a reducing agent and CO₂ to effectively neutralize alkalinity, remove Ca²⁺ and CrO₄²⁻, and reduce total dissolved solids without introducing new pollutants.

It should be noted that the reducing agent powder 160 (and its products) has a high density and tends to sink, resulting in long reaction times. Therefore, mechanical stirring is conventionally required. In this application, the structure of the concrete wastewater treatment device 10 is improved such that the gas outlet end 111 of the CO₂ input pipe 110 is close to or located in the groove 104, and the gas outlet direction is configured to induce turbulence and agitation in the reducing agent powder 160. That is, the reducing agent is placed at the CO₂ injection port. The CO₂ at the outlet reacts with water to not only provide a weak acidic environment for the reducing agent to accelerate the reaction rate but also generate an injection airflow similar to mechanical stirring for the reducing agent powder 160, inducing turbulence and agitation to further accelerate the reaction rate and improve treatment efficiency. Additionally, both the weak acidic environment and the mechanical stirring-like function for the reducing agent are achieved through CO₂ injection, i.e., through structural improvements and coordination, without adding extra devices or chemicals, resulting in low cost, high environmental friendliness, simple structure, and low maintenance difficulty.

It can be understood that to facilitate floating, the reducing agent powder 160 can be in the form of flakes with a large specific surface area, specifically selected according to actual needs.

In summary, the concrete wastewater treatment device 10 provided in this application has a simple structure and low maintenance cost. It not only uses the combination of reducing agent powder 160 and CO₂ to effectively neutralize alkalinity, remove Ca²⁺ and CrO₄²⁻, and reduce total dissolved solids but also through structural improvements and coordination, places the reducing agent powder 160 at the CO₂ outlet. The CO₂ at the outlet reacts with water to provide a weak acidic environment for the reducing agent, accelerating the reaction rate. Meanwhile, the injected CO₂ airflow provides a function similar to mechanical stirring for the reducing agent powder 160, inducing turbulence and agitation to further accelerate the reaction rate and improve treatment efficiency. Moreover, since both the weak acidic environment and the mechanical stirring-like function for the reducing agent are caused by CO₂ injection, no additional devices or chemicals are added, resulting in low concrete wastewater treatment costs and high environmental friendliness.

It should be noted that when the gas outlet end 111 of the CO₂ input pipe 110 is close to or located in the groove 104, and the gas outlet direction is configured to induce turbulence and agitation in the reducing agent powder 160, the gas outlet end 111 of the CO₂ input pipe 110 can be connected to the bottom wall of the groove 104, with the CO₂ outlet direction facing the inside of the first chamber 101, or the gas outlet end 111 of the CO₂ input pipe 110 can be connected to the side wall of the groove 104, with the CO₂ outlet direction facing the inside of the first chamber 101.

As shown in FIG. 2, in some embodiments, the groove 104 is located at the bottom side of the first chamber 101 in the direction of gravity. The gas outlet end 111 of the CO₂ input pipe 110 extends downward along the direction of gravity and extends into the groove 104. The gas outlet direction of the gas outlet end 111 of the CO₂ input pipe 110 faces the bottom wall of the groove 104.

Since the gas outlet direction of the gas outlet end 111 of the CO₂ input pipe 110 faces the bottom wall of the groove 104, the CO₂ output by the CO₂ input pipe is directed toward the bottom wall of the groove 104 and rebounded by the bottom wall of the groove 104. This is beneficial for fully agitating the reducing agent powder 160 and improving the efficiency and effect of concrete wastewater treatment.

As shown in FIGS. 1 and 2, in some embodiments, the concrete wastewater treatment device 10 further includes a first sedimentation tank 120 and an output pipe 130. The first sedimentation tank 120 is provided with a first overflow port 121 and a sewage discharge port 122.

The output pipe 130 includes a liquid inlet end 132 and a liquid outlet end 134. The liquid inlet end 132 is connected to the first liquid outlet 103 of the first chamber 101, the liquid outlet end 134 is connected to the first sedimentation tank 120, and the liquid outlet end 134 is positioned lower than the first overflow port 121 in the gravitational direction.

The liquid outlet end 134 being positioned lower than the first overflow port 121 in the gravitational direction means that during use, the concrete wastewater input into the first sedimentation tank 120 from the liquid outlet end 134 will only flow into the first sedimentation tank 120 and not directly flow out from the first overflow port 121. The wastewater will only flow out from the first overflow port 121 when the liquid level in the first sedimentation tank 120 is higher than or level with the first overflow port 121, allowing the concrete wastewater input into the first sedimentation tank 120 from the liquid outlet end 134 to fully settle and reducing the TDS of the concrete wastewater flowing out from the first overflow port 121. Since the output pipe 130 discharges the reacted concrete wastewater from the first chamber 101 to the first sedimentation tank 120 for sedimentation, calcium carbonate, iron hydroxide, chromium hydroxide, etc., formed in the reacted concrete wastewater can precipitate in the first sedimentation tank 120 and be discharged through the sewage discharge port 122, while the upper clear liquid can be discharged through the first overflow port 121. At the same time, since the liquid outlet end 134 is positioned lower than the first overflow port 121 in the gravitational direction, it prevents the concrete wastewater entering the first sedimentation tank 120 from the first chamber 101 from directly flowing out from the first overflow port 121, allowing the input concrete wastewater to fully settle in the first sedimentation tank 120 and reducing the TDS of the outflowing wastewater.

To facilitate sewage discharge, the bottom of the first sedimentation tank 120 is funnel-shaped, with the sewage discharge port 122 located at the lowest point of the bottom of the first sedimentation tank 120 in the gravitational direction. The sewage discharge port 122 is provided with a sewage discharge valve.

As shown in FIGS. 1 and 2, in some embodiments, the output pipe 130 includes a flexible segment 131 and a rigid segment 133. One end of the flexible segment 131 serves as the liquid inlet end 132, and the other end is connected to the rigid segment 133, with the end of the rigid segment 133 opposite to the flexible segment 131 serving as the liquid outlet end 134.

The length of the flexible segment 131 is greater than the distance between the first liquid outlet 103 and the rigid segment 133, and the flexible segment 131 is configured such that the buoyancy force from the concrete wastewater is greater than or equal to its gravity, allowing the flexible segment 131 to float in the concrete wastewater. The length of the flexible segment 131 is greater than the distance between the first liquid outlet 103 and the rigid segment 133—for example, the length of the flexible segment 131 is 2-100 times, such as 2-50 times, the distance between the first liquid outlet 103 and the rigid segment 133—which can be set according to actual needs.

Since the concrete wastewater discharged through the output pipe 130 contains calcium carbonate, iron hydroxide, chromium hydroxide, etc., which easily form scale inside the output pipe 130 and cause blockage, affecting the discharge efficiency and service life of the output pipe 130.

Therefore, through the above configuration, the flexible segment 131 can float in the concrete wastewater and deform with changes in the liquid level, reducing or inhibiting scale formation in the output pipe 130, lowering the risk of blockage, and extending the service life of the concrete wastewater treatment device 10.

In some embodiments, as shown in FIGS. 1 and 2, the first sedimentation tank 120 further includes a baffle 123 connected to the side wall of the first sedimentation tank 120, with a channel formed between the baffle 123 and the bottom wall of the first sedimentation tank 120. The baffle 123 divides the first sedimentation tank 120 into a main section 124 and an overflow section 125 that are in communication at the bottom.

The first chamber 101 and the flexible segment 131 are located in the main section 124, the rigid segment 133 is connected to the top of the baffle 123 with the liquid outlet end 134 located in the overflow section 125, and the first overflow port 121 is formed in the overflow section 125.

Through the above configuration, the position of the rigid segment 133 can be fixed, which helps to pull the flexible segment 131, ensuring that the flexible segment 131 always floats in the concrete wastewater during use. At the same time, the baffle 123 divides the first sedimentation tank 120 into a main section 124 and an overflow section 125 that are in communication at the bottom, with the first overflow port 121 formed in the overflow section 125, which is conducive to the concrete wastewater fully settling in the first sedimentation tank 120 before overflowing through the first overflow port 121, reducing the TDS of the outflowing wastewater.

In some embodiments, as shown in FIGS. 1 and 2, the rigid segment 133 is provided with a pH sensor 135.

Using the pH sensor 135 to monitor the pH of the concrete wastewater output from the rigid segment 133 helps control the CO2 flow and the amount of reducing agent added based on the data obtained from the pH sensor 135, which is conducive to improving the treatment efficiency and effect of concrete wastewater.

In some embodiments, as shown in FIGS. 1 and 2, the concrete wastewater treatment device 10 further includes a second wall 140 sleeved outside the first wall 100, forming a second chamber 141 between the second wall 140 and the first wall 100.

The second chamber 141 has a second liquid outlet 142, which is positioned higher than the first liquid outlet 103 in the gravitational direction, and the second liquid outlet 142 is connected to the liquid inlet end 132.

The provision of the second chamber 141 helps CO₂ further react sufficiently with calcium ions, etc. At the same time, the closed first chamber 101, second chamber 141, and output pipe 130 extend the output path of CO₂ to the first sedimentation tank 120, helping CO₂ react fully and reducing CO₂ overflow.

In some embodiments, as shown in FIGS. 1 and 2, the concrete wastewater treatment device 10 further includes a reducing agent addition mechanism 150, which includes a storage chamber 151 for carrying the reducing agent powder 160. The storage chamber 151 is located above the first chamber 101 in the gravitational direction, the outlet of the storage chamber 151 is connected to the first chamber 101, and a valve 152 is provided at the outlet of the storage chamber 151.

Through the above configuration, the reducing agent powder 160 can be added to the first chamber 101 under gravity, with a simple structure and easy operation, which helps reduce costs.

It should be noted that in actual use, a weight sensor (not shown) can be provided at the bottom of the storage chamber 151 to monitor the weight of the reducing agent powder 160 in the storage chamber 151. The weight sensor and the valve 152 can be configured to be interlocked, i.e., the valve 152 can be triggered to close after a preset weight of the reducing agent is added, with specific settings referable to related technologies.

In summary, the concrete wastewater treatment device and system provided in this application not only use the combination of reducing agent powder and CO₂ to effectively neutralize alkalinity, remove Ca²⁺ and CrO₄²⁻, and reduce total dissolved solids but also through structural improvements and coordination, place the reducing agent powder at the CO₂ outlet. The CO₂ at the outlet reacts with water to provide a weak acidic environment for the reducing agent, accelerating the reaction rate. Meanwhile, the injected CO₂ airflow provides a function similar to mechanical stirring for the reducing agent powder, inducing turbulence and agitation to further accelerate the reaction rate and improve treatment efficiency. Moreover, since both the weak acidic environment and the mechanical stirring-like function for the reducing agent are caused by CO₂ injection, no additional devices or chemicals are added, resulting in low concrete wastewater treatment costs and high environmental friendliness.

The above are only preferred embodiments of this application and are not intended to limit this application. For those skilled in the art, this application may have various modifications and changes. Any modifications, equivalent substitutions, improvements, etc., made within the spirit and principles of this application shall be included in the protection scope of this application.

1. A concrete wastewater treatment device, wherein the device comprises:
a first wall enclosing a first chamber for accommodating and treating concrete wastewater, wherein the first wall is provided with a first liquid inlet and a first liquid outlet communicating with the first chamber, the first liquid outlet is positioned higher than the first liquid inlet, the first chamber has a groove for containing reducing agent powder, which includes at least one of elemental iron, divalent iron compounds, and elemental aluminum; and
a CO₂ input pipe for delivering CO₂ into the first chamber, wherein the gas outlet end of the CO₂ input pipe is adjacent to or located within the groove, and the gas outlet direction is configured such that the delivered CO₂ induces turbulence and agitation in the reducing agent powder.

2. The concrete wastewater treatment device according to claim 1, wherein the groove is located at the bottom of the first chamber in the gravitational direction, the gas outlet end of the CO₂ input pipe extends downward in the gravitational direction into the groove, and the gas outlet direction of the CO₂ input pipe faces the bottom wall of the groove.

3. The concrete wastewater treatment device according to claim 1, further comprising a first sedimentation tank and an output pipe, wherein: the first sedimentation tank is provided with a first overflow port and a sewage discharge port; the output pipe includes a liquid inlet end and a liquid outlet end, the liquid inlet end is connected to the first liquid outlet of the first chamber, the liquid outlet end is connected to the first sedimentation tank, and the liquid outlet end is positioned lower than the first overflow port in the gravitational direction.

4. The concrete wastewater treatment device according to claim 3, wherein the output pipe comprises a flexible segment and a rigid segment, wherein one end of the flexible segment serves as the liquid inlet end, the other end is connected to the rigid segment, and an end of the rigid segment opposite to the flexible segment serves as the liquid outlet end;
the length of the flexible segment is greater than the distance between the first liquid outlet and the rigid segment, and the flexible segment is configured such that the buoyancy force from the concrete wastewater is greater than or equal to its weight, allowing the flexible segment to float in the concrete wastewater.

5. The concrete wastewater treatment device according to claim 4, wherein the first sedimentation tank further comprises a baffle: the baffle is connected to the sidewall of the first sedimentation tank, forming a channel between the baffle and the bottom wall of the first sedimentation tank, the baffle divides the first sedimentation tank into a main section and an overflow section that are in communication at the bottom; the first chamber and the flexible segment are located in the main section, the rigid segment is connected to the top of the baffle with the liquid outlet end in the overflow section, and the first overflow port is formed in the overflow section.

6. The concrete wastewater treatment device according to claim 4, wherein the rigid segment is equipped with a pH sensor.

7. The concrete wastewater treatment device according to claim 3, further comprising a second wall sleeved outside the first wall, forming a second chamber between the second wall and the first wall: the second chamber has a second liquid outlet positioned higher than the first liquid outlet in the gravitational direction, and the second liquid outlet is connected to the liquid inlet end.

8. The concrete wastewater treatment device according to claim 1, further comprising a reducing agent addition mechanism, which includes a storage chamber for holding the reducing agent powder: the storage chamber is located above the first chamber in the gravitational direction, with its outlet connected to the first chamber and equipped with a valve.

9. A concrete wastewater treatment system, wherein it comprises the concrete wastewater treatment device according to claim 1, a sand filter, and a clean water tank: the concrete wastewater treated by the device is delivered to the sand filter for filtration, and the filtered wastewater is then delivered to the clean water tank.

10. The concrete wastewater treatment system according to claim 9, further comprising a second sedimentation tank and a water storage tank: the concrete wastewater treated by the device is delivered to the second sedimentation tank for sedimentation; the second sedimentation tank is connected to the water storage tank via an overflow pipe, and the sand filter receives the wastewater from the water storage tank through a water pump.
